(19) United States
(12) Patent Application Publication
(10) Pub. No.: US 2026/0367595 A1
(43) Pub. Date: Nov. 19, 2026

(54) METHOD AND DEVICE FOR CONTROLLING AT LEAST ONE ON-BOARD DEVICE LOCATED IN AN AIRCRAFT

(71) Applicant: SAFRAN ELECTRONICS & DEFENSE, Paris (FR)

(72) Inventors: Olivier AVONDET, Moissy-Cramayel (FR); Damien LE BAIL, Moissy-Cramayel (FR)

(73) Assignee: SAFRAN ELECTRONICS & DEFENSE, Paris (FR)

(21) Appl. No.: 19/130,010

(22) PCT Filed: Nov. 10, 2023
(86) PCT No.: PCT/FR2023/051774

§ 371 Date: May 14, 2025

(30) Foreign Application Priority Data
Nov. 16, 2022 (FR) 2211926

(51) Int. Cl. G05B 15/02; B64D 47/00

(52) U.S. Cl. CPC G05B 15/02; B64D 47/00

(57) ABSTRACT

A device for controlling at least one device on board an aircraft based on flight data provided by at least one source device, the control device including a multi-core processor including: a first core; a second core; and an inter-core communication interface, the second core being isolated from the at least one on-board device and from the at least one source device, and the first core being configured to: provide, via the interface, input data obtained based on the flight data; obtain, via the interface, output data; and provide control data obtained based on the output data.

### TECHNICAL FIELD

This invention relates to the fields of control devices and on-board systems. More specifically, this invention relates to a device for controlling at least one device on board an aircraft, and an associated aircraft, control method, application method, set of computer programs and storage medium. This invention has a particularly advantageous, although in no way limiting, application for the implementation of devices for controlling electric motors for actuating flight controls.

### PRIOR ART

The invention lies, by way of non-limiting example, in a context in which the flight controls of an aircraft are produced by actuating electric motors. In this particular context, a control device (e.g. a computer) takes as input control commands (e.g. provided by a stick, or an autopilot) and data from sensors (e.g. an inertial unit, a Pitot probe), and supplies as output control signals for actuating motors (e.g. an actuator of an aileron).

Typically, such a control device makes use of several software components (i.e. several computer programs) to determine the control signals based on the pilot commands and the measured data. These software components, which respectively implement specific functions required for control, can be produced by different suppliers. However, the use of several programs on one and the same control device presupposes the solving of problems of integration and management of the executions of these different programs.

In the current state of the art, one solution consists in integrating several software components into one and the same program and in executing this program on a dedicated processor, such as a DSP (Digital Signal Processor). Such a solution allows to achieve a high processing speed while keeping the complexity of the control device low. These advantages are however counterbalanced by a certain number of drawbacks.

Specifically, with each new version of one of the software components, the shared and complex integration of the software components into the same program must be systematically redone and certified again. In addition, by using such a shared integration, an error of execution of one of the software components can lead to a general malfunction of the control device, a situation that must absolutely be avoided for critical applications such as aerospace.

There is consequently a need for a fast and low-complexity control device that allows to dissociate the executions of several programs.

### SUMMARY OF THE INVENTION

This invention aims at remedying all or part of the drawbacks of the prior art, particularly those set out previously.

According to an aspect of the invention, provision is made for a device for controlling at least one device on board an aircraft based on flight data provided by at least one source device, said control device comprising a multi-core processor including: a first core; a second core (separate from the first core); and an inter-core communication interface, the second core being isolated from said at least one on-board device and from said at least one source device, and the first core being configured to:
provide, via the inter-core communication interface, input data obtained based on the flight data;
obtain, via the inter-core communication interface, output data; and
provide, to said at least one on-board device, control data obtained based on the output data.

The term “multi-core processor” should here be understood to mean a processor (e.g. a microprocessor integrated into a single circuit) comprising several processing units (known as cores) which are physically separate and execute computer program instructions. Correspondingly, a “core” denotes a processing unit (i.e. a set of circuits within a processor) capable of executing the computer program instructions.

In the context of the invention, the term “flight data” denotes data characterizing a flight of the aircraft (i.e. comprising the different flight phases such as taxiing, takeoff, cruise, landing etc.). By way of illustration, the flight data may comprise command data provided by a flight control device (e.g. manual or automatic) and/or data measured by one or more sensors of the aircraft (e.g. an inertial unit, a Pitot probe, a temperature sensor).

Moreover, it is important to note that the second core is isolated from the on-board devices to be controlled and from the source devices producing the flight data and cannot communicate with these devices. In other words, the second core does not possess any active interface of communication external to the processor.

Thus, this invention makes provision for a control device (i.e. a platform) making it possible to execute on the second core a computer program (for example, a software component provided by a third-party entity) in a way that is isolated materially and temporally from a program executing on the first core.

Specifically, the proposed control device allows to execute: on the first core, a program implementing the function of control of the on-board devices; and on the second core, a program implementing a specific algorithm required for the control function. Within this meaning, this invention allows to make use of the hardware features of a multi-core processor to physically and temporally separate the executions of several programs within a control device.

Thanks to the proposed solution, an error of execution of a program executed on the second core does not necessarily lead to a malfunction of the control device, the first core being still able to implement the control function. Hence, by comparison with existing solutions, this invention allows to improve the dependability of the control device.

Furthermore, the proposed control device allows to execute on each of the cores a program with its own restrictions (i.e. temporal isolation between a program executed on the first core and a program executed on the second core).

Moreover, the use of a multi-core processor as proposed allows to achieve a high processing speed (i.e. computational frequency) while keeping the complexity low. In particular, the proximity between the cores of the processor allows to quickly exchange data between several programs via the inter-core communication interface (e.g. comprising high-frequency random access memories). The control device can thus operate at a high operating frequency.

For these reasons, this invention supplies a control device which is fast and of low complexity making it possible to separate, materially and temporally, the executions of several programs. Thus, the proposed control device allows to meet the specific restrictions of the on-board systems in terms of complexity, processing speed, size and dependability.

According to an embodiment, the first core is configured to execute a so-called control program obtaining the flight data (coming from said at least one source device) and providing the control data (to said at least one on-board device). And, according to this embodiment, the second core is configured to execute a so-called application program obtaining the input data (coming from the first core) and providing the output data (to the first core).

The term “program” here refers to a computer program comprising instructions executable by at least one core, processor, or a computer.

According to this embodiment, the control program (e.g. produced by a supplier) implements the control function and thus provides the interface with the source devices providing the flight data and with the on-board devices to be controlled. And, the application program (e.g. produced by another supplier) itself implements a specific algorithm required for the control function (e.g. a force law algorithm).

In general, this embodiment allows to materially and temporally separate the executions of the control program and of the application program.

In particular, an error of execution of the application program does not cause an error of execution of the control program. The two programs can be executed at the same time with no deadlocks (i.e. no corruption between these programs), which contributes to improving the dependability of the control device.

Moreover, the application program does not possess any external communication interface and cannot communicate with the source devices producing the flight data and the on-board devices to be controlled. In other words, all the data exchanged by the application program are communicated via the inter-core communication interface with the control program.

This embodiment advantageously allows to independently certify the control program and the application program, the exchanges between these programs being able to be considered as predefined interfaces. The respective developments of these programs are also made independent.

Moreover, this embodiment allows to guarantee to the respective suppliers of the control program and of the application program the privacy of their programs. Thanks to the proposed solution, it is not necessary to have access to the source code of the application program to control the on-board device. The application program can thus be provided in binary form for example.

According to an embodiment, the multi-core processor of the control device is a dual-core digital signal processor comprising the first and the second core.

The term “digital signal processor” should here be understood to mean a processor, all the components of which are implemented on one and the same integrated circuit and the architecture of which is dedicated to (optimized for) the implementation of digital signal processing functions, more commonly known by the acronym DSP.

By making use of a dual-core DSP optimized for digital signal processing, this embodiment advantageously allows to achieve a high processing speed while keeping the complexity low. This results in an improvement of the performance of the proposed control device in terms of cost, size, and energy consumption.

According to an embodiment, the inter-core communication interface comprises: two one-way exchange memories; or one two-way exchange memory.

By way of illustration, the exchange memories of the inter-core communication interface can be high-frequency random access memories.

This embodiment allows to rapidly exchange data between the cores of the processor, and therefore between programs respectively executing on these cores. In this way, this embodiment helps provide a control device with a high processing speed.

According to an embodiment, the inter-core communication interface comprises means (e.g. a communication bus) for transmitting trigger signals (also known as “events”) between the first core and the second core.

This embodiment allows one of the cores of the processor to trigger the execution of one or more steps on another core of the processor. This embodiment thus allows to coordinate the execution of different programs respectively executed on different cores.

In particular, according to an embodiment, the first and the second core communicate via the inter-core communication interface using only the exchange memory or memories and the means for transmitting trigger signals. More precisely, the second core does not comprise, according to an embodiment, any active communication interface external to the processor.

According to another aspect of the invention, provision is made for an aircraft comprising: a control device in accordance with the invention; at least one source device; and at least one on-board device.

In particular, said at least one source device supplies flight data and said at least one on-board device is controlled by the control device based on the flight data.

The proposed aircraft possesses the advantages described above in relation to the control device in accordance with the invention.

According to an embodiment, said at least one on-board device comprises an electrical actuator of a control surface of the aircraft.

This embodiment, thanks to the use of the proposed control device, allows to implement the flight controls of an aircraft reliably and quickly.

In the context of the invention, it is also possible to envision other embodiments in which said at least one on-board device comprises a digitally-controlled inverter.

According to another aspect of the invention, provision is made for a method for controlling at least one device on board an aircraft based on flight data provided by at least one source device, the control method comprising steps, implemented by a first core of a multi-core processor, of:
providing, via an inter-core communication interface of the multi-core processor, input data obtained based on the flight data;
obtaining, via the inter-core communication interface, output data; and
providing, to said at least one on-board device, control data obtained based on the output data.

The proposed control method has the advantages described above in relation to the control device in accordance with the invention.

According to an embodiment, the control method is implemented by the control device in accordance with the invention.

It is here recalled that the proposed control device allows to execute, in a temporally and materially separated way: on the first core, a control program implementing the control function of the on-board devices; and on the second core, an application program implementing an algorithm required for the control function.

According to an embodiment, the control method comprises a step of sending, by the first core to a second core of the processor, of a signal for triggering the providing, by an application program (executed on the second core) of said output data obtained based on said input data. More precisely, this triggering signal is sent by way of an inter-core communication interface of the multi-core processor.

According to this embodiment, the first core triggers, when required, the implementation by the second core of a specific algorithm required for the control function (e.g. an algorithm of the force law implemented by the application program). Thus, this embodiment allows to optimize the use of the computational resources (i.e. of the cores of the processor) and the energy consumption of the control device.

More generally, this embodiment allows to coordinate the executions of different programs respectively executed on different cores of the processor (e.g. the control program executed on the first code and the application program executed on the second core).

According to an embodiment, the control method comprises a step of sending, by the first core to the second core, of a signal for triggering the booting of the application program. In particular, this trigger signal is sent by way of the inter-core communication interface of the multi-core processor.

This embodiment allows the first core to start the execution by the second core of the application program.

According to an embodiment, the control method comprises steps, implemented by the second core to boot the application program, of:
if the application program is loaded onto the second core (i.e. onto a memory of the second core), initializing configuration data of the application program and triggering an execution, by the second core, of the application program; and
otherwise, loading the application program onto the second core (i.e. onto a memory of the second core) and triggering the booting of the application program.

Note that the implementation by the second core of the steps described above to boot the application program is triggered by the receiving, from the first core, of a signal for triggering the booting of the application program.

This embodiment allows, without locking the execution of the control program on the first core, to load (or update) the application program onto the second core and launch its execution.

According to an embodiment, the control method comprises a step, implemented by the second core, of verifying a digital signature associated with the application program.

This embodiment allows to verify the integrity of the application program and to authenticate the supplier of this program. Below is a more detailed description of how the signature can be generated and verified.

More generally, this embodiment allows to guarantee the security of the control device and to protect it from potential computer attacks (e.g. the modification of the application program for malicious purposes).

According to an embodiment, the control method comprises a step of stopping or reinitializing the second core, implemented by the second core and triggered by an error of execution of the application program.

This embodiment allows to handle an error of execution of the application program and thus helps improve the dependability of the control device.

According to an aspect of the invention, provision is made for a computer program, the so-called control program, comprising instructions for executing the steps, implemented by a first core of a multi-core processor, of a control method in accordance with the invention, when said control program is executed by the first core.

In particular, the control program is executed by the first core of the multi-core processor of a control device in accordance with the invention.

According to an aspect of the invention, provision is made for a set of computer programs comprising: a control program in accordance with the invention; and at least one other program. Said at least one other program comprises instructions for executing the steps, implemented by a second core of a multi-core processor, of a control method in accordance with the invention, when said at least one other program is executed by the second core.

In particular, said at least one other program is executed by the second core of the multi-core processor of a control device in accordance with the invention.

According to another aspect of the invention, provision is made for an application method implemented by a second core of a multi-core processor, the second core being isolated in that it communicates only with a first core of the multi-core processor and via an inter-core communication interface, said application method comprising steps of:
obtaining, via the inter-core communication interface, input data;
obtaining output data based on the input data; and
providing, via the inter-core communication interface, output data.

According to another aspect of the invention, provision is made for a computer program, the so-called application program, comprising instructions for implementing the steps of an application method in accordance with the invention, when the application program is executed by a second core of a multi-core processor.

The application program is in particular executed by the second core of the multi-core processor, of a control device in accordance with the invention.

According to an aspect of the invention, provision is made for a storage medium readable by a computer comprising: a control program in accordance with the invention; and/or a set of computer programs in accordance with the invention; and/or an application program in accordance with the invention.

In the context of the invention, a computer program can be formed of one or more subparts stored in one and the same memory or in separate memories. The program can use any programming language, and be in the form of source code, object code or intermediate code between source code and object code, such as in a partially compiled form, or in any other desirable form.

Furthermore, a storage medium can be any entity or device capable of storing the program. For example, the medium can include a storage means, such as a non-volatile memory or ROM, for example a CD-ROM or a microelectronic circuit ROM, or else a magnetic recording means, for example a diskette or a hard disk. Moreover, the storage medium can be a transmissible medium such as an electrical or optical signal, which can be routed via an electrical or optical cable, by radio or by a telecommunication network or by a computer network or by other means. The program according to the invention can in particular be downloaded over a computer network. Alternatively, the information medium can be an integrated circuit in which the program is incorporated, the circuit being suitable for executing or for being used in the execution of the method in question.

### BRIEF DESCRIPTION OF THE DRAWINGS

Other features and advantages of this invention will become apparent from the description provided hereinafter, illustrating embodiments of the invention given by way of example and devoid of any limitation, with reference to the attached drawings:

FIG. 1 shows an example of a software and hardware architecture of an aircraft according to an embodiment of the invention;

FIG. 2 shows an example of a software and hardware architecture of a control device according to an embodiment of the invention;

FIG. 3A and FIG. 3B respectively show an example of a software and hardware architecture of an aircraft and the steps of a control method according to an embodiment of the invention; and

FIG. 4A and FIG. 4B respectively show an example of a software and hardware architecture of an aircraft and the steps of a control method according to an embodiment of the invention.

### DESCRIPTION OF THE EMBODIMENTS

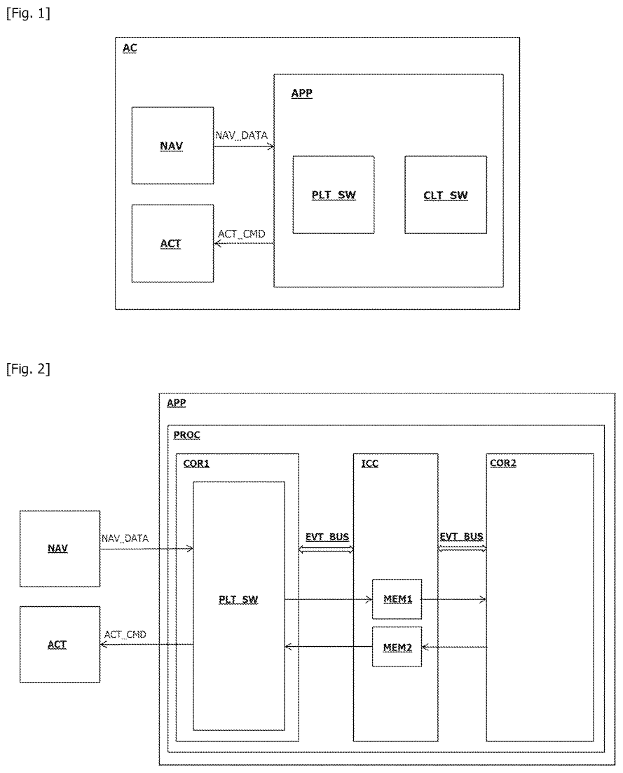

FIG. 1 shows an example of a software and hardware architecture of an aircraft according to an embodiment of the invention. In particular, FIG. 1 is described hereinafter to introduce the invention and exemplify a particular context of application thereof.

As illustrated on FIG. 1, the aircraft AC comprises: a control device APP; at least one source device NAV; and at least one on-board device ACT. More precisely, the control device APP is configured to: take, as input, flight data NAV_DATA produced by said at least one source device NAV; and provide, as output, control data ACT_CMD to control said at least one on-board device ACT.

The flight data NAV_DATA may comprise command data NAV_CMD coming from a flight control device (automatic or manual) of the aircraft AC. Also, the flight data may comprise data measured by one or more sensors of the aircraft AC, such as an inertial unit, a Pitot probe, a temperature sensor, etc.

This invention is applicable, in particular, to the control of the electrical motors for actuating the flight control of an aircraft. The description hereinafter of this invention refers to this particular context, given by way of illustrative example and without any limitation. In particular, one could envision embodiments in which the on-board devices ACT to be controlled comprise one or more digitally-controlled inverters.

Thus, according to an embodiment, said at least one on-board device ACT to be controlled comprises one or more control surface actuators (e.g. electrical actuators) of the aircraft AC. For example, on the basis of flight control commands and/or data from sensors, the control device APP controls one or more control surface actuators ACT of the aircraft AC.

Note that, in the context of the invention, the control device APP requires the execution of several computer programs (in particular produced by different suppliers) to control the on-board devices ACT.

As illustrated by FIG. 1, the control device APP requires the execution of a control program PLT_SW and of an application program CLT_SW. More precisely, the control program PLT_SW implements the control function and provides the interface with the source devices NAV and with the on-board devices ACT; and the application program CLT_SW implements a specific algorithm required to control these devices ACT. For example, the application program CLT_SW can implement a force law algorithm making it possible to determine the setpoints to be applied to a control surface of the aircraft AC.

This latter example will be described in more detail here in order to illustrate an application of the invention. The control program PLT_SW obtains, from the source devices NAV, data from an inertial unit and a desired attitude of the aircraft AC. Based on the inertial data, it determines a current attitude and a speed of the aircraft AC. Next, the control program PLT_SW supplies to the application program CLT_SW: the current attitude; the speed; and the desired attitude. Using a force law, the application program CLT_SW determines an amount of bank to be applied to an aileron to produce the desired attitude as a function of the current attitude and of the speed of the aircraft AC. The application program CLT_SW supplies the computed amount of bank to the control program PLT_SW which then determines an activation time of a control surface actuator to achieve this amount of bank.

As mentioned previously, this invention makes provision for a control device APP (i.e. a platform) making it possible to execute any application program CLT_SW in a materially and temporally isolated way.

The application program CLT_SW can be of any type and is typically provided by a third-party entity (for example delivered by a supplier to the equipment manufacturer implementing the control device). Thus, the architecture of the proposed control device APP is independent of the application program CLT_SW.

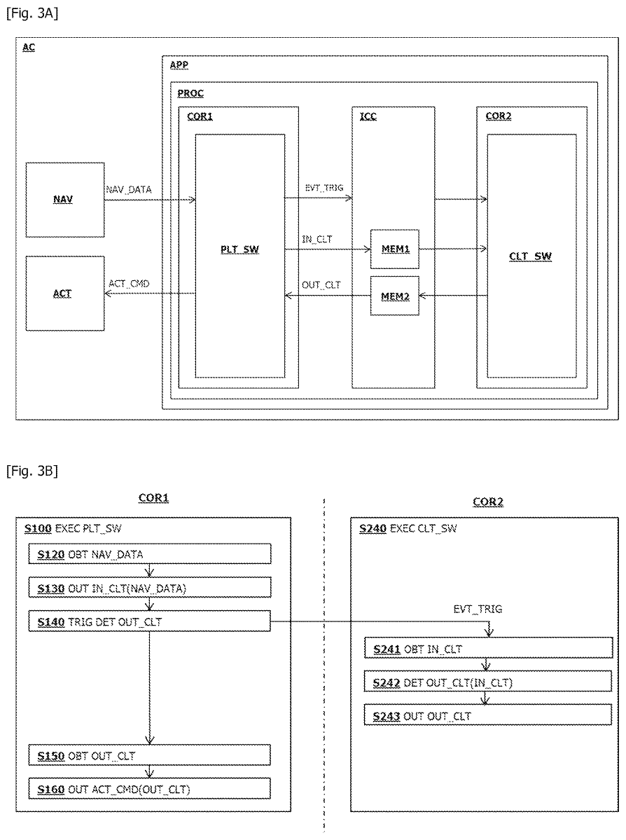

For this reason, we will first describe the architecture of the proposed control device APP with reference to FIG. 2, then the operation of the proposed control device APP with reference to the following figures.

FIG. 2 shows an example of a software and hardware architecture of a control device according to embodiments of the invention. This figure details the architecture of the control device APP shown with reference to FIG. 1.

As illustrated by FIG. 2, the proposed control device APP comprises a multi-core processor PROC. Furthermore, the control device APP may comprise any type of component needed for its operation, such as a power source, connection ports, communication modules, memories, etc.

The processor PROC comprises: at least a first core COR1 and a second core COR2; and an inter-core communication interface ICC.

Note that each of the cores COR1-COR2 of the multi-core processor PROC can independently execute computer program instructions. In this regard, each of the cores COR1-COR2 can respectively comprise at least one element from among: one or more cache memories, a program counter, one or more registries, and one or more computing units.

According to an embodiment, the processor PROC comprises only two cores COR1-COR2. However, in the context of the invention, other embodiments could be envisioned in which the processor PROC comprises more than two cores.

According to an embodiment, the processor PROC is a microprocessor (i.e. a processor, all the components of which are integrated into one and the same circuit). More specifically, the processor PROC is a multi-core DSP according to an embodiment. Such a processor has an optimized architecture to implement functions of digital processing of the signal as fast as possible. The use of a DSP advantageously results in an improvement of the performance of the control device APP in terms of complexity, size, and energy consumption.

Thus, according to an embodiment, the processor PROC is a dual-core DSP.

The inter-core communication interface ICC comprises: two one-way exchange memories MEM1 and MEM2 (e.g. high-frequency random access memories); and means EVT_BUS (e.g. a communication bus) for transmitting trigger signals (also known as “events”).

The memory MEM1 is used to exchange data coming from the first core COR1 bound for the second core COR2, i.e. data written by the first core COR1 to the memory MEM1 and read by the second core COR2. Similarly, the memory MEM2 is used to exchange data coming from the second core COR2 bound for the first core COR1, i.e. data written by the second core COR2 to the memory MEM1 and read by the first core COR1.

The memories MEM1-MEM2 allow to exchange data between the cores COR1-COR2. The proximity between the cores COR1-COR2 allows to exchange, with a high communication bitrate, data between programs executing on these cores, which thus helps provide a fast control device APP.

The transmitting means EVT_BUS allow to exchange trigger signals between the cores COR1-COR2. Such signals are used to trigger, based on one of the cores COR1-COR2, the execution of one or more steps on another core COR1-COR2, which allows to coordinate the executions of programs on the cores COR1-COR2.

The first core COR1 is configured to execute the control program PLT_SW. As illustrated by FIG. 2, the control program PLT_SW provides the interface with the source devices NAV and the on-board devices ACT to be controlled. More generally, the control program PLT_SW implements the control function (i.e. management of the hardware, interfaces, and sequencing of the control of the on-board devices).

The first core COR1 can exchange data with a program executed on the second core COR2 using the memories MEM1-MEM2 of the interface ICC. Also, the first core COR1 can trigger the execution of one or more steps by a program executed on the second core COR2 by sending trigger signals by way of the transmitting means EVT_BUS of the interface ICC. More generally, the first core COR1 governs the data exchanges and the events.

The second core COR2 is configured to communicate only with the first core COR1 via the interface ICC. In other words, the second core COR2 is configured such that it does not possess any active communication interface external to the processor PROC. In this sense, the second core COR2 is isolated from the source devices NAV and from the on-board devices ACT to be controlled.

Thus, the proposed control device APP allows to execute any program on the second core COR2 in a way that is materially and temporally isolated from the control program PLT_SW executed on the first core COR1.

The advantages of the control device APP are the result, as previously described, of the physical and temporal separation of the executions of several programs.

In particular, the proposed control device APP allows to execute on each of the cores COR1-COR2 a program with its own time restrictions (i.e. temporal isolation). In other words, the control device APP allows to use different frequency domains between the control program PLT_SW executed on the first core COR1 and a program executed on the second core COR2.

Moreover, an error of execution of a program executed on the second core COR2 does not lead to a malfunction of the control device APP. The control device APP also allows to guarantee the privacy of a program executed on the second core COR2. Advantageously, it is possible to certify the control device APP (with the control program PLT_SW) and independently of a program executed on the second core COR2, which considerably simplifies the certification by comparison with the existing solutions.

Moreover, the control device APP allows to achieve a processing speed (i.e. a computational frequency) which is high while keeping the complexity low. More generally, the control device APP allows to meet the specific restrictions of the on-board systems in terms of complexity, processing speed, size and reliability.

The architecture of the control device APP having been introduced, its operation will be described hereinafter with reference to the following figures.

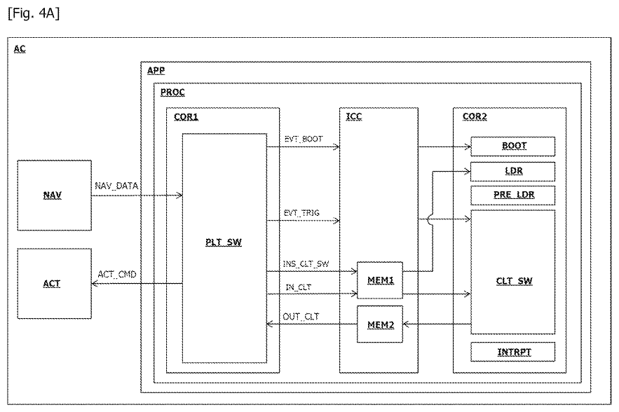

FIG. 3A and FIG. 3B respectively represent an example of a software and hardware architecture of an aircraft and of the steps of a control method according to an embodiment of the invention. FIG. 3B illustrates a control method according to an embodiment of the invention implemented by the control device APP of FIG. 3A.

As illustrated by FIG. 3A, according to this embodiment, the first core COR1 of the control device APP is configured to execute the control program PLT_SW and the second core COR2 of the control device APP is configured to execute the application program CLT_SW.

As illustrated by FIG. 3B, according to this embodiment, the control method comprises at least one of the steps described below. Note that the steps of the proposed control method implemented by the first core COR1 are denoted S1XX and that the steps implemented by the second core COR2 are denoted S2XX.

At step S100, the first core COR1 executes the control program PLT_SW comprising instructions for implementing the steps S120 to S160 described hereinafter.

More generally, the control program PLT_SW may comprise instructions for performing each of the steps S1XX of the control method in accordance with the invention and implemented by the first core COR1, when these instructions are executed by the first core COR1.

At step S240, the second core COR2 executes the application program CLT_SW comprising instructions for implementing the steps S241 to S243 described below. In particular, the term “application method” is used to refer to the set of steps S241 to S243 implemented by the second core COR2, when it executes the application program CLT_SW.

It should be emphasized that the control program PLT_SW and the application program CLT_SW are executed concurrently, i.e. during overlapping time periods. In other words, the steps S100 and S240 are performed concomitantly.

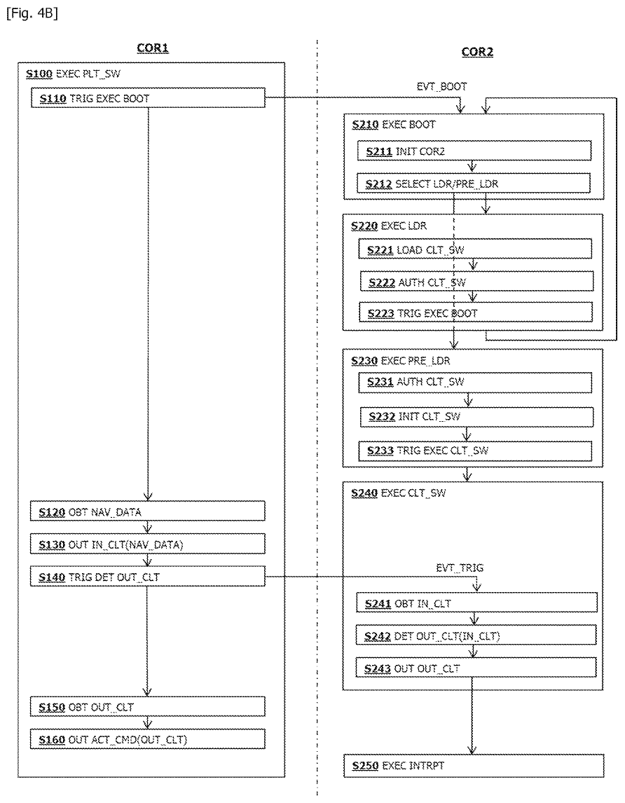

The management of the execution of the application program CLT_SW by the second core COR2 (i.e. loading, launching, execution error) is more amply described hereinafter with reference to FIGS. 4A and 4B.

At step S120, the first core COR1 (i.e. the control program PLT_SW) obtains the flight data NAV_DATA coming from the source devices NAV. For example, the first core COR1 obtains, during this step: data coming from an inertial unit; and a flight control command such as a desired attitude of the aircraft AC.

At step S130, the first core COR1 (i.e. the control program PLT_SW) supplies input data IN_CLT to the second core COR2 (i.e. to the application program CLT_SW) by way of the interface ICC. In particular, the first core COR1 writes, at step S130, the input data IN_CLT to the memory MEM1 of the interface ICC, the input data IN_CLT being obtained based on the flight data NAV_DATA.

For example, the control program PLT_SW can determine a current attitude and a speed of the aircraft AC based on the inertial data. Thus, according to this example, the input data IN_CLT provided to the application program CLT_SW may comprise a current attitude, a speed of the aircraft AC and a desired attitude.

At step S140, the first core COR1 (i.e. the control program PLT_SW) triggers the provision by the second core COR2 (i.e. by the application program CLT_SW) of output data OUT_CLT. More precisely, the first core COR1 sends, at step S140, a trigger signal EVT_TRIG to the second core COR2 by way of the transmitting means EVT_BUS (not shown FIG. 3A) of the interface ICC. The signal EVT_TRIG triggers the implementation of the steps S241 to S243 by the second core COR2.

At step S241, the second core COR2 (i.e. the application program CLT_SW) obtains the input data IN_CLT coming from the first core COR1 (i.e. coming from the control program PLT_SW). In fact, the second core COR2 reads, in step S241, the input data IN_CLT on the memory MEM1 of the interface ICC.

At step S242, the second core COR2 (i.e. the application program CLT_SW) obtains the output data OUT_CLT based on the input data IN_CLT.

Returning to the example above, the application program CLT_SW can determine, using a force law, an amount of bank to be applied to an aileron to produce a desired attitude of the aircraft AC as a function of its current attitude and of its speed.

At step S243, the second core COR2 (i.e. the application program CLT_SW) supplies the output data OUT_CLT to the first core COR1 (i.e. to the control program PLT_SW) by way of the interface ICC. The second core COR2 writes, at step S243, the output data OUT_CLT to the memory MEM2 of the interface ICC.

At step S150, the first core COR1 (i.e. the control program PLT_SW) obtains the output data OUT_CLT from the second core COR2 (i.e. from the application program CLT_SW) by way of the interface ICC. The first core COR1 reads, at step S150, the output data OUT_CLT on the memory MEM2 of the interface ICC.

At step S160, the first core COR1 (i.e. the control program PLT_SW) supplies, to the on-board devices ACT, the control data ACT_CMD obtained based on the output data OUT_CLT.

Considering the example above, the control program PLT_SW can determine an activation time of a control surface actuator to achieve the amount of bank computed by the application program CLT_SW.

Note that the application program CLT_SW may comprise at least an initialization service and a periodic service, these services being respectively trigged by trigger signals. Thus, the implementation of the steps S241 to S243 may correspond to the provision of the initialization service or of the periodic service of the application program CLT_SW.

The periodic service of the application program CLT_SW can be triggered, repeatedly over time, by the control program PLT_SW to obtain output data OUT_CLT. Also, the control method may comprise a plurality of iterations of the steps S120 to S160 and, correspondingly, the application method may comprise a plurality of iterations of the steps S241 to S243.

FIG. 4A and FIG. 4B respectively show an example of a software and hardware architecture of an aircraft and of the steps of a control method according to embodiments of the invention. Precisely, these figures are described hereinafter to detail the management of the execution of the application program CLT_SW by the control device APP described with reference to FIGS. 3A and 3B.

As illustrated on FIG. 4A, according to an embodiment, the second core COR2 is configured to execute at least one of the following programs: a boot program BOOT; a loading program LDR; an initialization program PRE_LDR; and an interrupt management system INTRPT (also called an interrupt vector). The respective functions of these programs are described below with reference to the steps of FIG. 4B.

At step S100, and as previously described, the first core COR1 executes the control program PLT_SW comprising instructions for implementing the steps S120 to S160. According to the embodiment illustrated by FIGS. 4A and 4B, the control program PLT_SW further comprises instructions to perform the step S110.

At step S110, the first core COR1 (i.e. the control program PLT_CW) triggers the booting of the application program CLT_SW. To do so, the first core COR1 sends a trigger signal EVT_BOOT to the second core COR2 by way of the transmitting means EVT_BUS (not shown on FIG. 3A) of the interface ICC. The signal EVT_BOOT triggers the implementation of the step S210 by the second core COR2.

Following the step S110, the first core COR1 implements the steps S120 to S160 as previously described with reference to FIGS. 3A and 3B.

At step S210, triggered by the receiving of the signal EVT_BOOT, the second core COR2 executes the boot program BOOT comprising instructions for implementing the steps S211 and S212.

At step S211, the second core COR2 (i.e. the boot program BOOT) boots and/or initializes the second core COR2.

At step S212, the second core COR2 (i.e. the boot program BOOT) selects the triggering of the execution of the loading program LDR or of the initialization program PRE_LDR as a function of the presence of the application program CLT_SW on a memory of the second core COR2.

If (and only if) the application program CLT_SW is loaded (i.e. recorded, stored) on a memory of the second core COR2, the second core COR2 (i.e. the boot program BOOT) triggers at step S212 an execution of the initialization program PRE_LDR. In this case, the control method continues at step S230.

Otherwise, if the application program CLT_SW is not loaded on a memory of the second core COR2, the second core COR2 (i.e. the boot program BOOT) triggers at step S212 an execution of the loading program LDR. In this case, the control method continues at step S220.

Note here that the selection made at step S212 can also be made as a function of the version of the application program CLT_SW. According to such an embodiment, if the application program CLT_SW loaded on a memory of the second core COR2 corresponds to an obsolete or earlier version of this program, then the second core COR2 (i.e. the boot program BOOT) triggers at step S212 an execution of the loading program LDR to load an up-to-date version of the application program CLT_SW.

At step S220, the second core COR2 executes the loading program LDR comprising instructions for performing at least the steps S221 and S223.

At step S221, the second core COR2 (i.e. the loading program LDR) loads or updates the application program CLT_SW on a memory of the second core COR2.

More precisely, the second core COR2 obtains the instructions INS_CLT_SW (e.g. the binary code) of the application program CLT_SW coming from the first core COR1 by way of the interface ICC. Thus, according to an embodiment, the first core COR1 writes the instructions of the application program CLT_SW in the exchange memory MEM1 of the interface ICC; and the second core COR2 reads the instructions of the application program CLT_SW on the exchange memory MEM1.

According to an embodiment, the loading program LDR further comprises instructions for performing the step S222.

At step S222, the second core COR2 (i.e. the loading program LDR) verifies a digital signature associated with the application program CLT_SW.

For example, the signature of the application program CLT_SW can be generated as follows. The supplier of the application program CLT_SW possesses a private key/public key pair and a certificate associating the public key with the supplier. The supplier applies a hash function to the code of the application program CLT_SW to obtain a fingerprint, then encrypts this fingerprint with its private key to obtain the signature. The supplier supplies to the control device APP: the code of the application program CLT_SW; the associated signature; and its certificate.

According to this example, the control device APP can verify the signature of the application program CLT_SW as follows. The control device APP, on the one hand, determines a fingerprint of the code of the application program CLT_SW and, on the other hand, decrypts the digital signature using the public key of the certificate of the supplier, then compares the results of these two operations. If the fingerprint computed by the control device APP matches the decrypted signature, then the signature of the application program CLT_SW is valid.

If (and only if) the result of the verifying step S222 is positive (i.e. valid signature), the control method continues at step S223. Otherwise (i.e. invalid signature), the second core COR2 is inhibited and will not execute the application program CLT_SW. Specifically, the authentication of the application program CLT_SW expires; this can mean that the application program CLT_SW has been modified by a malicious entity.

Thus, by verifying the signature of the application program CLT_SW, the control device APP verifies the integrity of the application program CLT_SW and authenticates (i.e. checks the identity of) the supplier of this program. This allows to advantageously improve the security of the control device APP and to protect it from possible computer attacks.

At step S223, the second core COR2 (i.e. the loading program LDR) triggers the booting of the application program. The control method thus continues at step S210.

At step S230, the second core COR2 executes the initialization program PRE_LDR comprising instructions for implementing at least the steps S232 and S233.

According to an embodiment, the initialization program PRE_LDR further comprises instructions for performing the step S231.

At step S231, the second core COR2 (i.e. the initialization program PRE_LDR) verifies a digital signature associated with the application program CLT_SW. The step S231 can, for example, be implemented similarly at step S221 described above.

At step S232, the second core COR2 (i.e. the initialization program PRE_LDR) initializes configuration data (e.g. a configuration table) of the application program CLT_SW.

At step S233, the second core COR2 (i.e. the initialization program PRE_LDR) triggers an execution of the application program CLT_SW by the second core COR2.

At step S240, triggered by the step S233, the second core COR2 executes the application program CLT_SW and thus implements the steps S241 to S243 as described with reference to FIGS. 3A and 3B.

However, if an error of execution of the application program CLT_SW occurs, then the second core COR2 triggers the execution of the interrupt management program INTRPT (i.e. an interrupt vector).

At step S250, triggered by an error of execution of the application program CLT_SW, the second core COR2 executes the interrupt management program INTRPT comprising instructions to stop and/or reinitialize the second core COR2.

The proposed solution, by making use of the hardware architecture of the multi-core processor PROC, advantageously allows to dissociate the executions of the control program PLT_SW and of the application program CLT_SW. Thus, an error of execution of the application program CLT_SW does not lead to an error of execution of the control program PLT_SW and to a fault of the control device APP. Specifically, the control program PLT_SW can, despite an error of execution of the application program CLT_SW, continue to fulfil the control function of the on-board devices ACT. To do so, the control program PLT_SW can, for example, use a failsafe operating mode not requiring the use of the application program CLT_SW, or else trigger the execution of the application program CLT_SW again once the second core COR2 has been reinitialized.

Note that the order in which the steps of a method in accordance with the invention are sequenced, particularly with reference to the attached drawings, constitutes only one exemplary embodiment without any limitation, variants being possible. In particular a method in accordance with the invention may comprise one or more iterations of the steps described above, particularly with reference to the attached drawings.

Moreover, the reference signs are not limiting of the scope of the protection, their sole function being to simplify the understanding of the claims.

Those skilled in the art will understand that the embodiments and variants described above constitute only non-limiting examples of implementation of the invention. In particular, those skilled in the art may envision any adaptation or combination of the embodiments and variants described above in order to meet a specific requirement.

1. A device for controlling at least one device on board an aircraft based on flight data provided by at least one source device, said control device comprising a multi-core processor including: a first core; a second core; and an inter-core communication interface, the second core being isolated from said at least one on-board device and from said at least one source device in that it is configured to communicate only with the first core and via the inter-core communication interface, the first core being configured to execute a control program implementing the control function of said at least one on-board device and comprising instructions for:
providing, via the inter-core communication interface, input data obtained based on the flight data;
obtaining, via the inter-core communication interface, output data; and
providing, to said at least one on-board device, control data-obtained based on the output data, and
the second core being configured to execute an application program comprising instructions for:
obtaining, via the inter-core communication interface, the input data;
obtaining the output data based on the input data; and
providing, via the inter-core communication interface, the output data.

2. The control device according to claim 1, wherein the processor is a dual-core digital signal processor comprising the first core and the second core.

3. The control device according to claim 1, wherein the inter-core communication interface comprises: two one-way exchange memories; or one two-way exchange memory.

4. The control device according to claim 1, wherein the inter-core communication interface comprises means for transmitting trigger signals between the first and the second core.

5. An aircraft comprising: a control device according to claim 1; at least one source device providing flight data; and at least one on-board device controlled by the control device based on the flight data.

6. The aircraft according to claim 5, wherein said at least one on-board device comprises an electrical actuator of a control surface of the aircraft.

7. A method for controlling at least one device on board an aircraft based on flight data provided by at least one source device, the control method being implemented by a control device according to claim 1, and the control method comprising steps, implemented by the first core (COR1) of the multi-core processor of the control device, of:
providing, via the inter-core communication interface of the processor, input data obtained based on the flight data;
obtaining, via the inter-core communication interface, output data; and
providing, to said at least one on-board device, control data obtained based on the output data.

8. The control method according to claim 7, comprising a step of sending, by the first core to the second core of the processor, of a signal for triggering the providing, by the application program, of said output data obtained based on said input data.

9. The control method according to claim 8, comprising a step of sending, by the first core to the second core, of a signal for triggering the booting of the application program.

10. The control method according to claim 9, comprising steps, implemented by the second core to boot the application program of:
if the application program is loaded onto the second core initializing configuration data of the application program and triggering an execution, by the second core of the application program; and
otherwise, loading the application program onto the second core and triggering the booting of the application program.

11. The control method according to claim 8, comprising a step, implemented by the second core, of verifying a digital signature associated with the application program.

12. A non-transitory computer readable medium having stored thereon a control program comprising instructions which, when executed by the first core of the multi-core processor of a control device according to claim 1, cause the processor to implement the steps of a control method comprising:
providing, via the inter-core communication interface of the processor, input data obtained based on the flight data;
obtaining, via the inter-core communication interface, output data; and
providing, to said at least one on-board device, control data obtained based on the output data.

13. An application method implemented by the second core of the multi-core processor of a control device according to claim 1, the second core being isolated in that it communicates only with the first core of the processor and via the inter-core communication interface, said application method comprising steps of:
obtaining, via the inter-core communication interface, input data;
obtaining output data based on the input data; and
providing, via the inter-core communication interface, output data.

14. A non-transitory computer readable medium having stored thereon an application program comprising instructions which, when executed by the second core of the multi-core processor of a control device according to claim 1, cause the processor to implement the steps of an application method comprising:
obtaining, via the inter-core communication interface, input data;
obtaining output data based on the input data; and
providing, via the inter-core communication interface, output data.
